(19) United States
(12) Patent Application Publication
(10) Pub. No.: US 2017/0210407 A1
(43) Pub. Date: Jul. 27, 2017

(54) FOLDABLE STROLLER

(71) Applicant: INNOVATIONMAKERS LIMITED, Finchley, London (GB)

(72) Inventors: Markus WARWICK, Finchley, London (GB); Samantha WARWICK, Finchley, London (GB)

(21) Appl. No.: 15/321,559

(22) PCT Filed: Jun. 24, 2015
(86) PCT No.: PCT/EP2015/025037

§ 371 Date: Dec. 22, 2016

(30) Foreign Application Priority Data
Jun. 25, 2014 (GB) 1411264.3
Feb. 17, 2015 (GB) 1502654.5

(51) Int. Cl. B62B 7/06; B62B 9/08; B62B 9/24; B60B 19/00; B62B 7/08; B62B 7/00

(52) U.S. Cl. CPC B62B 7/064; B62B 7/08; B62B 7/004; B62B 9/24; B60B 19/003; B62B 9/08; B62B 2205/20; B62B 2301/25; B62B 2301/02

(57) ABSTRACT

A foldable stroller, comprising a frame (10), at least one leg (16) pivotally mounted at the lower end of the frame (10) and pivotal with respect thereto between an operable configuration in which said frame (10) extends at an angle relative to vertical and said at least one leg (16) extends from the front of the frame (10), and a folded configuration in which said leg (16) is located behind the backrest (200). The stroller further comprises a rear mount (22) extending, in the operable configuration, substantially vertically downward from an intermediate location along the length of the frame (10) and being pivotally mounted to the frame (10) such that, in a fully folded configuration, the rear mount (22) can be pivoted to a position substantially parallel to and behind the backrest (200). A rigid linking arm (28) is secured between the at least one leg (16) and the rear mount (22) such that when the leg (16) is pivoted, corresponding pivoting of the rear mount (22) is effected. A pivot mechanism between the leg (16) and the frame (10) is provided with a lock having an actuator.

This invention relates to a foldable stroller that can be moved between an unfolded, operable configuration and a folded, portable configuration.

There are many known types of foldable strollers for enabling convenient transportation of infants and young children. Such strollers generally comprise a backrest, a seat portion pivotally linked to the backrest, and three or four legs mounted with wheels.

It is a common occurrence in use of known such conveyances that an occupant will, for time to time, wish to walk for varying distances, or may be compelled to do so to negotiate rough ground or obstacles such as stairs. In other circumstances, a younger child may start a family outing willing to walk themselves, and may enjoy doing so, but the family has no choice but to wheel or even carry the transportation device as well in case the child tires part way through, or to carry the child if this is not done.

Other scenarios include walking the child to nursery and then having to push an empty buggy home and then back to the nursery to collect the child, and parents using public transport with cumbersome buggies which can be difficult to get onto buses and trains with pushchairs, shopping bags and child. These scenarios can act as a barrier to parents doing more activities with their children. Attempts to address these issues have concentrated on reducing the weight of the standard buggy, by reducing its size, changing the way the product folds and in some cases being able to remove the wheels in order to get it into a container which can be carried.

UK Patent Application No. 2506989 describes a buggy having a rear frame and a seat, whereby the seat is pivotally mounted to the rear frame, and the buggy is configured to fold by pivoting the seat upward toward the rear frame, thereby providing a relatively compact folded structure. The seat is forwardly projecting, in the unfolded configuration, and a wheel is mounted on a leg projecting downwardly from its front edge. The rear frame is backwardly curved (relative to the seat) and provides a rear axle on which two rear wheels are mounted. A rucksack, or similar container, is removably mounted on the back of the rear frame. When the buggy is in the unfolded configuration, the rucksack can be used to carry shopping or the like. When the buggy is in the folded configuration, the rucksack can be used to carry the buggy on the user's back.

There are a number of problems associated with known buggy arrangements. For example, in the arrangement of GB2506989, when the buggy is in the folded configuration, the overall structure is still quite long and bulky, and the rear wheels project from the bottom of the rear frame, such that they rest and bump against the user's back or legs when the structure is being carried like a rucksack. This may be uncomfortable and, if the wheels are dirty, this can result in dirt from the wheels being transferred to a user's clothes. Another significant drawback of this known arrangement is the additional complexity and weight as a result of the provision of a rucksack on the structure.

Furthermore, the weight of the frame may not be carried very close to the back in any circumstances as the rucksack is located behind the straps, potentially affecting the centre of gravity when the rucksack is used for its primary function of carrying additional weight other than that of the child, which may be significant. If the rucksack is lightly loaded, this may make it uncomfortable and ungainly, in use, adversely affecting the weight distribution for the user, and forcing the user to continually counterbalance against the majority of the weight of the frame, as the weight will, in effect, be pulling away from the body, rather than towards it, potentially affecting the user's balance and upsetting their centre of gravity. With the rucksack fully loaded, counterbalancing the weight of the frame on the back, the overall weight may be very high and this would be a significant drawback. If the buggy is in use and the rucksack is fully loaded this may also cause tipping issues, with the weight of the rucksack pulling the buggy backwards onto its rear wheels alone, potentially causing significant safety issues.

Numerous other problems and drawbacks are associated with known arrangements. For example, many existing assemblies cannot be transformed from the folded to the unfolded configuration, or vice versa, without using both hands, which may cause significant difficulty if the user needs one hand to hold a child.

Aspects of the present invention seek to address at least some of the issues associated with prior art strollers.

In accordance with a first aspect of the present invention, there is provided a foldable stroller, comprising a frame having a backrest and a seat portion, at least one leg pivotally mounted at a lower end of said frame and pivotal with respect thereto between an operable configuration in which said frame extends at an angle relative to vertical and at least one leg extends from the front of the frame, and a folded configuration in which said at least one leg is located behind said backrest, wherein a wheel is mounted at or adjacent a distal end of the or each leg, the stroller further comprising a rear mount carrying an axle on which at least one wheel is mounted, said rear mount extending, in said operable configuration, substantially vertically downward from an intermediate location along the length of said frame and being pivotally mounted to said frame such that, in a fully folded configuration, said rear mount can be pivoted to a position substantially parallel to and behind said backrest, and a rigid linking arm secured between said at least one leg and said rear mount such that when said at least one leg is pivoted, corresponding pivoting of said rear mount is effected via said linking arm, wherein a first pivot mechanism between said at least one leg and said frame is provided with a releasable lock for selectively preventing pivoting of said at least one leg relative to said lower end of said frame, said lock comprising an actuator communicably coupled to a second pivot mechanism between said mount and said frame, wherein said actuator is configured to lock said first pivot mechanism when said mount is in either said operable or said fully folded configuration, and release said first pivot mechanism during transitions between said operable and fully folded configurations.

The stroller may comprise a first releasable locking device for locking said mount in said fully folded configuration. A single-handedly actuable release mechanism may be provided for disengaging said locking device and releasing said mount for pivotal movement relative to said frame.

The stroller may comprise a second locking device for automatically locking said second pivot mechanism when said mount is in said fully operable configuration. In this case, the stroller may comprise a release mechanism for disengaging said second locking device and releasing said second pivot mechanism to permit pivotal movement of said mount relative to said frame.

The rear mount may be secured to said frame at a substantially central location relative to the length of the stroller including said at least one leg.

The frame may comprise a pair of parallel opposing, longitudinal bars, each comprising first and second bar sections, each first bar section being telescopically mounted in a respective second bar section, wherein each said first bar section configured for movement relative to a respective second bar section between a first fully extended configuration and a second fully retracted configuration. In this case, the stroller may comprise a locking mechanism for automatically locking said first bar section relative to said second bar section when it is in either said fully extended or fully retracted configuration.

In an exemplary embodiment, the stroller may comprise one or more handle members at or between the upper end of the frame, and a height of said one or more handle members may be adjustable when said stroller is in said operable configuration.

An exemplary embodiment of the stroller of the invention may comprise a seat of a bucket seat configuration, having a lower portion which defines the seat portion and an upper portion extending therefrom defining the backrest.

The stroller may comprise straps in respect of the backrest, which straps are operable as a harness for securing an occupant in the stroller when in the operable configuration, and operable as shoulder straps for transporting the stroller on a user's back when in the folded configuration.

The above-mentioned backrest may be substantially rigid such that, when the front wheel is pivoted toward the rear of the frame, in the folded configuration, the backrest can be pulled forward to provide a planar support which rests against a user's back when the stroller is being carried on their shoulders.

In accordance with an exemplary embodiment of the invention, the frame may comprise a pair of parallel bars having a lower cross bar connected therebetween, wherein the backrest and seat portion comprise a single, at least partially resilient flexible seat member, mounted between extending across substantially the whole width between the parallel bars.

The rear mount may comprise a rigid, generally U-shaped support, extending from the frame and pivotally mounted thereto by means of a pair of opposing elongate pivotal linkages.

The wheel or wheels on the at least one leg and/or the axle on the rear mount may comprise at least one omni wheel. In this case, the stroller may further comprise a braking mechanism provided in respect of said at least one omni wheel. The at least one omni wheel may comprise a pair of opposing, parallel discs, each carrying a plurality of rollers around their circumferential edge, said discs being coupled together by means of a substantially concentric coupling plate defining a concentric, upstanding flange between said discs, wherein said braking mechanism comprises a substantially vertical braking leg extending generally diametrically between said discs and terminating in a brake shoe defining a recess, wherein said braking leg is biased to a first configuration in which said brake shoe is above and removed from said flange, the braking mechanism further comprising an actuating device for applying a downward force to said braking leg and causing said recess in said braking shoe to move to a second configuration in which it engages with said flange defined by said coupling ring. The brake shoe may be further provided at its circumferential edge with a pair of contoured surfaces which, upon actuation of said braking mechanism, engage with immediately adjacent rollers.

The or each wheel at the front of said stroller and the or each wheel at the rear of said stroller may be provided with a braking mechanism, and a single actuation device may be provided which, when actuated, causes the braking mechanism in respect of the front and rear wheels to be applied substantially simultaneously.

According to another aspect of the present invention, there is provided a non-motorised conveyable vehicle comprising a frame and at least one omni wheel comprises a pair of opposing, parallel discs, each carrying a plurality of rollers around their circumferential edge, said discs being coupled together by means of a substantially concentric coupling plate defining a concentric, upstanding flange between said discs, wherein said braking mechanism comprises a substantially vertical braking leg extending generally diametrically between said discs and terminating in a brake shoe defining a recess, wherein said braking leg is biased to a first configuration in which said brake shoe is above and removed from said flange, the braking mechanism further comprising an actuating device for applying a downward force to said braking leg and causing said recess in said braking shoe to move to a second configuration in which it engages with said flange defined by said coupling ring.

The brake shoe may be further provided at its circumferential edge with a pair of contoured surfaces which, upon actuation of said braking mechanism, engage with immediately adjacent rollers.

The vehicle may comprise at least one wheel at its rear and at least one wheel at its front, at least one of said wheels comprising an omni-wheel, each of said wheels comprising a braking mechanism, and a single actuation device may be provided which, when actuated, causes the braking mechanism in respect of the front and rear wheels to be applied substantially simultaneously.

It will be appreciated that the above-mentioned non-motorised conveyable vehicle may comprise a stroller, but it may also comprise a manually conveyable vehicle, such as a shopping trolley or the like, or even a wind-powered vehicle, such as a land yacht, or the like, and this aspect of the present invention is not intended to be in any way limited in this regard.

These and other aspects of the present invention will be apparent from the following specific description in which embodiments of the present invention are described, by way of examples only, and with reference to the accompanying drawings, in which:

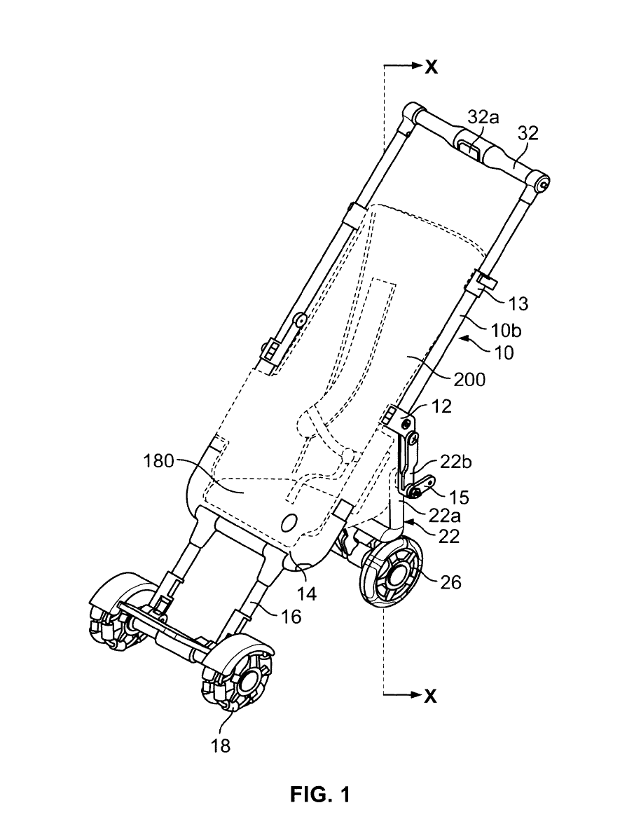

FIG. 1 is a schematic perspective left side view of a foldable stroller according to an exemplary embodiment of the present invention, in the operable configuration;

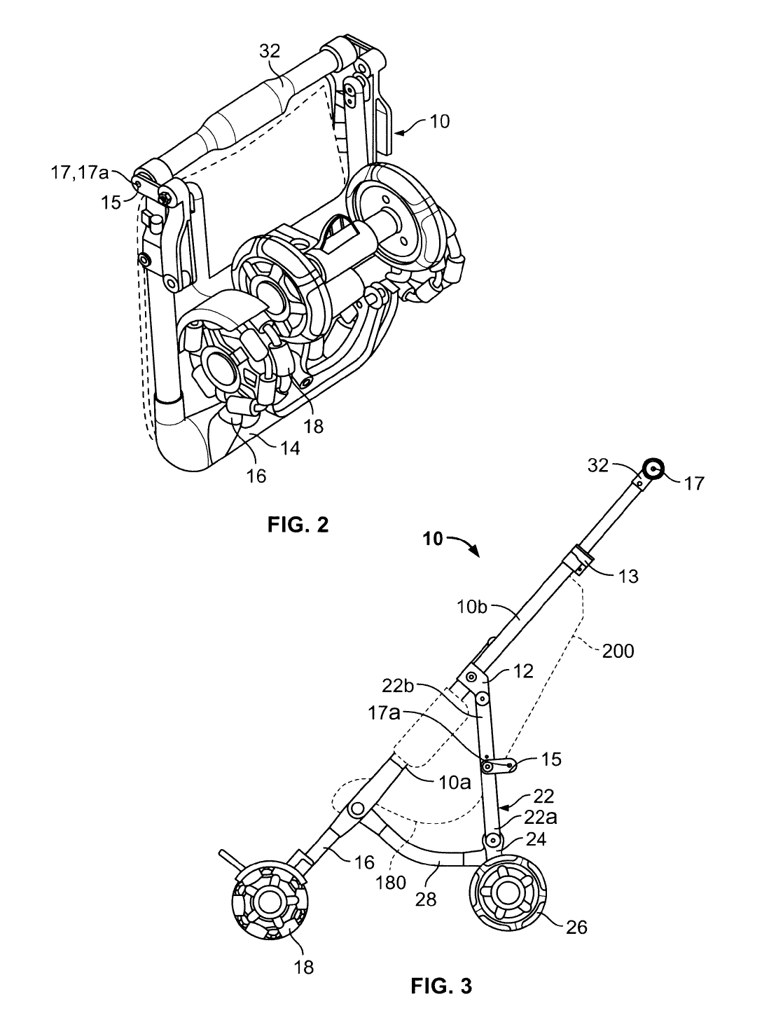

FIG. 2 is a schematic perspective rear view of the stroller of FIG. 1 in the folded configuration;

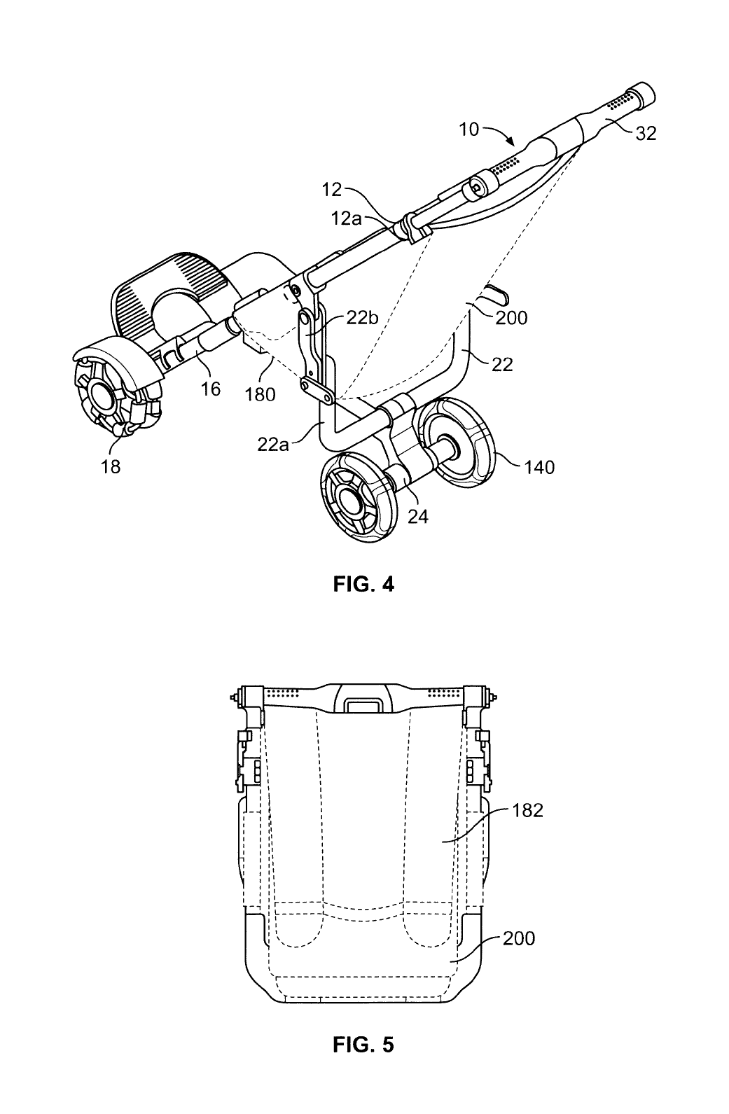

FIG. 3 is a schematic side view of the stroller of FIG. 1;

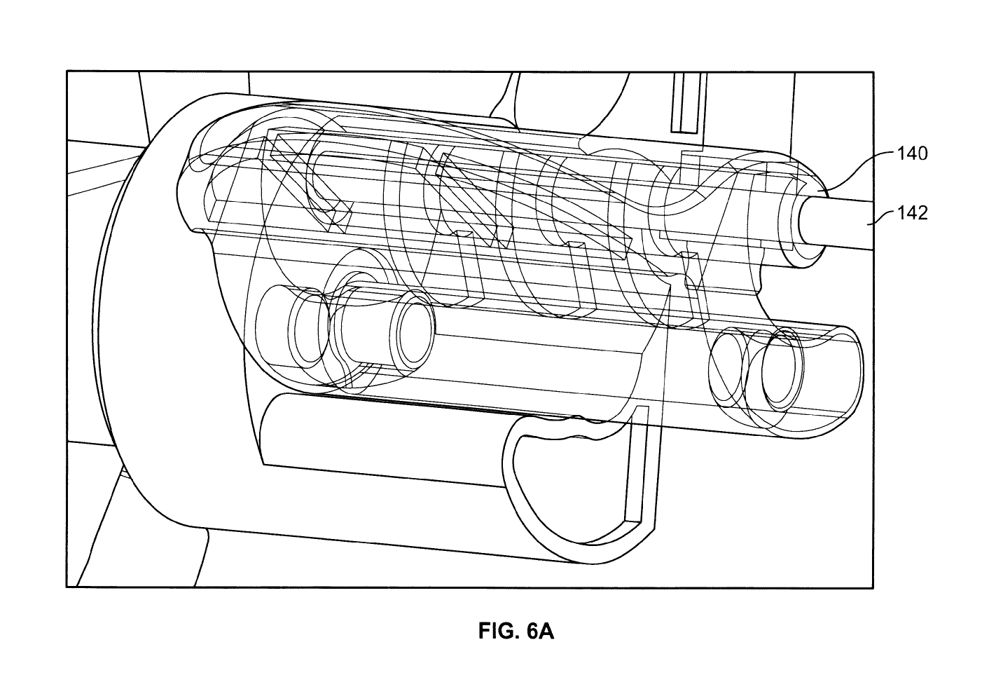

FIG. 4 is a schematic perspective rear view of the stroller of FIG. 1;

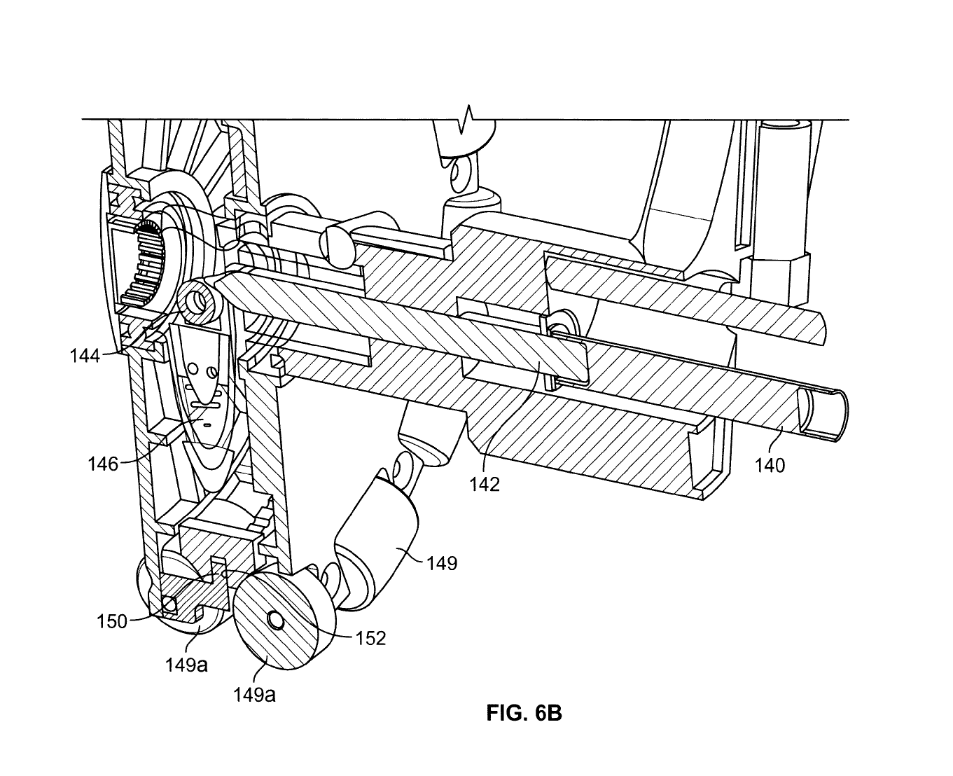

FIG. 5 is a schematic front view of the stroller of FIG. 2;

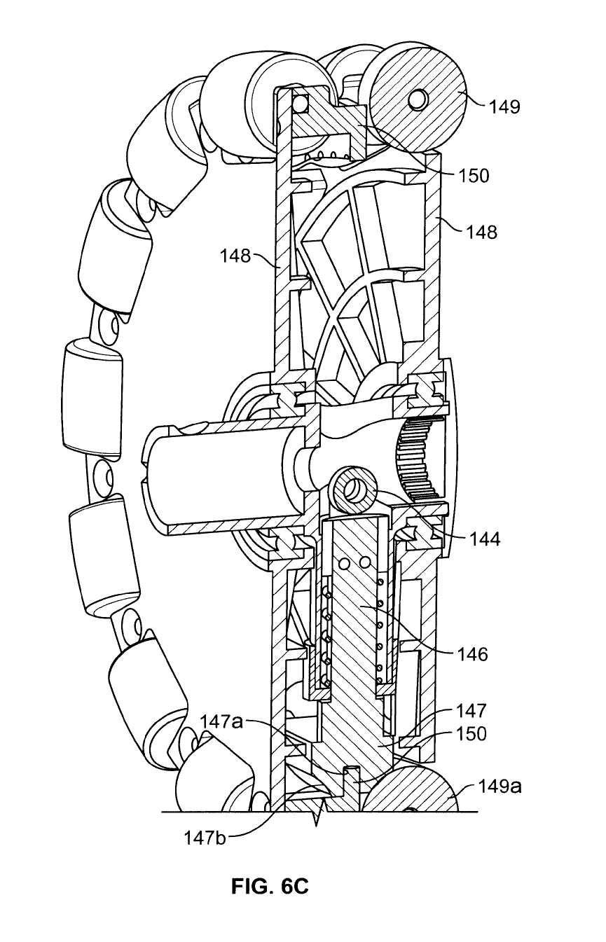

FIG. 6a is a schematic cut-away portion of braking mechanism, illustrating the ramp action of the coupling between the braking lever and the bar;

FIG. 6b is a schematic partial cut-away view of the stroller of FIG. 1, illustrating the braking mechanism used in an exemplary embodiment of the present invention;

FIG. 6c is a schematic cut-away section of an omni-wheel, illustrating the braking mechanism used in an exemplary embodiment of the present invention and

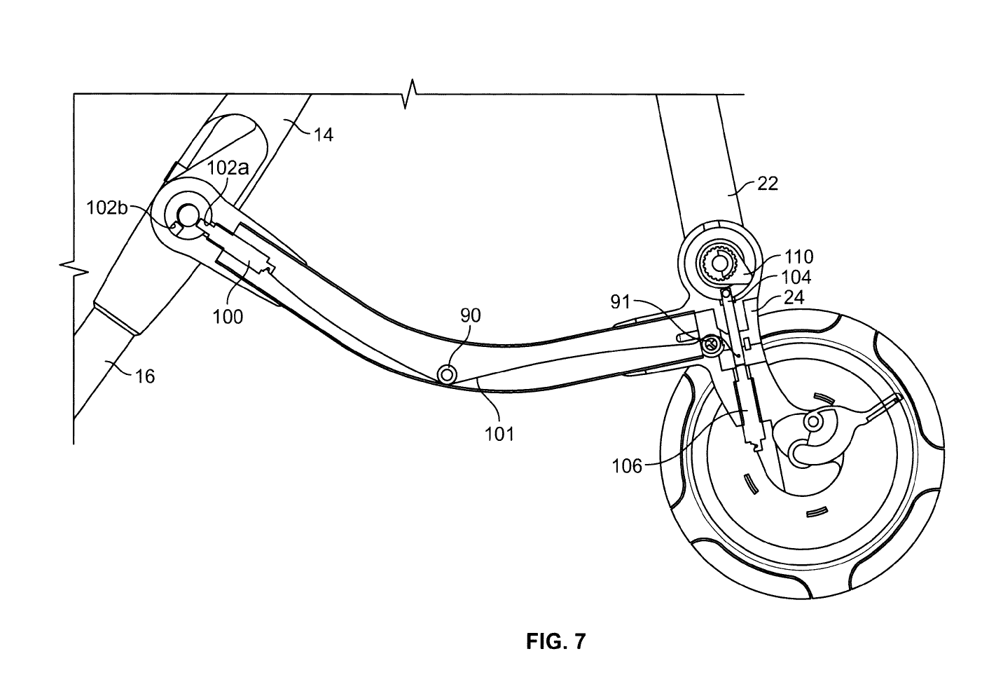

FIG. 7 is a partial, cut-away side view of the stroller of FIG. 1, illustrating schematically the pivotal locking mechanism.

Referring to FIG. 1 of the drawings, a stroller according to an exemplary embodiment of the present invention comprises a generally U-shaped frame 10 comprised of two parallel side bars having a lower cross bar 14 therebetween. A pair of legs extend from the lower cross bar 14 and are pivotally mounted thereto. When the stroller is in the operable configuration shown in FIG. 1, the parallel bars of the frame 10 extend toward the rear of the stroller at a significant angle to the vertical axis X-X, and the legs 16 extend downwardly from the front of the stroller (toward the ground) at substantially the same angle as the frame 10. A wheel 18 is provided at the distal end of each of the legs 16, with the axis of rotation thereof being substantially parallel to the axial length of the lower cross bar 14. The parallel bars forming the sides of the frame 10 are each comprised of two bar sections 10a, 10b, telescopically mounted together via a collar 12. Each lower bar section 10a is secured, or formed integrally with, a respective end of the lower cross bar 14 and the upper bar section 10b is telescopically adjustable relative to the lower bar section 10a between a first, fully retracted position in which its upper, distal end is adjacent to the collar and most of its length is within the lower bar section 10a, and a second, fully extended position, with locking means (not shown) being provided to lock the upper bar section 10b relative to the lower bar section 10a in one of the above-mentioned positions.

At the upper end of each of the upper bar sections 10b, there is provided a locking sleeve 13, and a handle 32 is telescopically mounted within the upper bar sections 10b, via the locking sleeves 13. The height of the handle can be continuously adjusted between a fully retracted position, in which the upper part of the handle 32 is adjacent the upper ends of the upper bar sections 10b, and a maximally extended position. When the locking sleeve is released, a user can manually adjust the height of the handle 32, up and down, relative to the frame, and, when a desired height is reached, lock the handle at the required height by means of the locking sleeves 13.

Referring additionally to FIG. 3 of the drawings, a generally U-shaped mount 22 is attached between the parallel bars of the frame 10, so as to extend downwardly, substantially vertically, from the rear of the frame 10, at a location which is generally central relative to the full length of the frame 10 and legs 16 combined, when in the operable configuration. An axle 24 is coupled to the mount 22 at the curved lower end thereof, and a pair of wheels 26 is coupled to the axle 24, the wheels 26 being mounted for rotation about an axis which is parallel to the axial length of the lower cross bar 14. Each of the parallel side arms of the U-shaped mount 22 is formed in two sections 22a, 22b. The lower section 22a of each arm is secured to, or formed integrally with, respective ends of the curved lower end thereof. An upper arm section 22b is provided on each side of the U-shaped mount 22, having a first end pivotally secured at an upper end of a respective lower arm section 22a, and a second end pivotally secured to an outwardly extending portion of the collar 12. A locking release lever 15 is provided in respect of the pivotal connection between each upper arm 22b and the respective lower arm 22a of the mount 22.

A bucket seat is provided, suspended between the lower cross bar 14 and the opposing locking sleeves 13, the seat having a seat portion 180 and a backrest portion 200. The seat extends across the width defined by the parallel bars of the frame 10, and may be secured thereto as required. The seat is formed of a resiliently flexible material, and the backrest 200 may be provided with additional, rigid support or padding so as to prevent significant deformation thereof. The configuration of the seat can be seen more clearly in FIG. 4 of the drawings.

A rigid, curved bar 28 extends from the middle of the lower cross bar 14 to the centre of the axle 24. The assembly is held in the fully operable configuration illustrated in, for example, FIG. 1 by a locking mechanism in respect of the pivotal connection between the upper and lower arms 22a, 22b of the U-shaped mount 22 and a locking mechanism in respect of the pivotal connection between the legs 16 and the lower cross bar 14, to be described later.

When the assembly is required to be folded for transportation, the lock between the upper and lower arms 22a, 22b of the U-shaped mount is released by rotation of the lever 15 such that the user can rotate the lower part of the mount, up and back, toward the rear of the frame 10. This has the effect of releasing the pivotal mechanism between the legs 16 and the lower cross bar 14 (as will be described later), such that the rotational movement of the U-shaped mount 22 causes corresponding rotation of the legs, back and up toward the rear of the frame, via the rigidly connected curved bar 28. When the legs 16 and the U-shaped mount 22 are fully rotated, such that the wheels thereon are adjacent the rear of the frame (or backrest 200), the pivotal mechanism between the legs 16 and the lower cross bar 14 locks again, automatically (as will be explained later), holding the legs 16 in the fully retracted or “folded” position. The upper bar sections 10b of the frame are released and pushed into the lower bar sections 10a, and locked in the fully retracted position by the above-mentioned locking means associated with the collar 12.

Each end of the handle 32 is provided with a protruding pin 17 and, when the assembly is folded and the handle is fully retracted, the protruding pins 17 can be engaged by a respective aperture 17a provided at the end of each locking lever 15, thus securing the U-shaped mount in the folded configuration. The assembly, in its fully folded and secured configuration is illustrated in FIG. 2, and it will be appreciated that, in this configuration, the assembly is fully secured in the folded configuration and can, thus, be carried without accidentally becoming unfolded. The backrest portion 200 of the seat can be pulled forward to as to form a planar surface that rests against a user's back when the assembly is carried on a user's shoulders, as can be seen more clearly in FIG. 5 of the drawings. The straps 182, which serve to secure a child in the seat when the stroller is in the operable configuration can also be used as shoulder straps to enable the folded assembly to be carried on a user's shoulders.

As stated above, the pivotal mechanism between the cross bar 14 and the legs 16 includes a releasable locking mechanism, which is locked when the assembly is in a fully extended or retracted position, and automatically unlocked when it is required to fold or unfold the assembly. Referring to FIG. 7 of the drawings, a spring indent pin 100, extending from within the curved bar 28 is spring biased toward engagement with a recess 102a provided in the pivot mechanism. In this configuration, the pivot mechanism is locked and the relative orientation between the legs and the lower cross bar 14 is fixed. A cable 101 is connected to the spring indent pin 100, passing under a first roller 90 in the curved bar 28 and over a second roller 91 at the end of the curved bar 28, and terminates at an elongate actuator 104 provided in the axle 24 at the rear of the stroller. A cam mechanism 110 is rotatably mounted in proximity to the upper end of the actuator 104 and communicably coupled to the pivoting mechanism between the upper and lower arms 22a, 22b of the U-shaped mount 22, such that rotation of the mount 22, either toward the unfolded or folded configuration causes rotation of the cam 110. The cam 110 is configured such that it, when it engages with the actuator 104, the actuator moves linearly down, pulling the cable 101 and, thereby, overcoming the spring bias of the spring indent clip 100, pulling it out of the recess 102a and releasing the pivotal mechanism between the legs 16 and the lower cross bar 14. The downward movement of the actuator 104 also causes a downward force to be applied to a second spring indent clip 106, against its bias. When the mount 22 has rotated to its fully folded or unfolded configuration, the profile of the cam 110 is so configured that it becomes disengaged from the upper end of the actuator 104, thereby releasing the downward force applied thereto. Thus, the second spring indent clip 106 springs back to its previous position, pushing the actuator 104 back to its previous position, and releasing the tension in the cable 101. Once the tension in the cable has been released, the bias of the first spring indent clip 100 causes it to spring back into the second recess 102b (when the front legs are in the folded configuration), thereby once again locking the pivotal mechanism.

From the folded position, if it is required to unfold the assembly for use, this can be achieved by a single handed action as follows. A push button actuator 32a is provided which is connected to a linear retraction mechanism within the handle. Depression of the push button 32a causes the retraction mechanism to retract the pins 17 in the ends of the handle, and thus release the levers 15. The U-shaped mount 22 starts to drop (i.e. pivot) under its own weight, and such pivotal movement causes the lock in the pivotal mechanism between the legs 16 and the lower cross bar 14 to be released (as described above). The legs 16 start to pivot under their own weight, and the upper bars 10b automatically extend (again, simply by the weight of the assembly pulling downwardly), until the entire assembly is in a fully unfolded configuration. The locking mechanism between the upper and lower arms 22a, 22b of the mount 22 is configured to lock automatically in the fully vertical configuration. Thus, the user can now place a child safely into the seat, before securing the straps and adjusting the height of the handle 32 if required.

At least one pair of wheels 18 26, at the ends of the legs 16 or on the axle 24, may comprise so-called omni-wheels which are wheels with small rollers around the circumference, the rollers being at an angle to the direction of movement of the stroller itself. In the exemplary embodiments illustrated herein, the omni-wheels are provided at the front of the stroller, but they may equally be provided at the rear and may also be interchangeable. Referring back to FIG. 4, for example, a brake lever 140 is provided for enabling a brake to be selectively applied to the wheels. In one exemplary embodiment of the present invention, the brake lever 140 may be configured to apply a respective braking mechanism simultaneously to both the front and rear wheels, by a single action. In alternative embodiments, a braking mechanism may be provided in respect of the front or rear wheels only. Many wheel braking systems are known. However, known braking mechanisms for omni-wheels tend to provide complex systems for engaging all of the rollers on each wheel, which are not only costly, but also unnecessarily increase the weight of the overall assembly, which is clearly undesirable.

Thus, referring to FIGS. 6a and 6b of the drawings, a novel omni-wheel braking mechanism will now be described, for use in exemplary embodiments of the present invention, but also in other manually conveyable vehicles employing one or more omni-wheels. Thus, rotation of the lever 140 causes corresponding linear movement of a bar 142 coupled thereto. This is achieved by a ramp configuration in the coupling between the lever 140 and the bar 142 which, when rotated, forces the bar 142 to move in a linear direction, as can be seen more clearly in FIG. 6a of the drawings.

Referring to FIGS. 6b and 6c of the drawings, the bar 142 is tapered to a point at its distal end, so as to define a chamfered outer surface which engages with an actuating disc 144. It can be seen from the figures that the omni-wheel comprises a pair of generally circular plates 148, each carrying individually rotatable rollers 149 around its circumferential edge. The plates 148 are coupled together by a coupling ring 150. An elongate sprung brake leg 146 extends downwardly from the actuating disc 144, and terminates in a brake shoe 147. The brake shoe 147 is provided with a recess 147a and contoured opposing edges 147b. In use, actuation of the brake lever 140 causes linear movement of the bar 142, such that its chamfered edges engage with, and apply and increasing downward pressure to, the actuating disc 144. The downward movement of the disc 144 is transferred to the brake leg, causing it to move downward, such that the recess 147a engages over the coupling ring 150 and thus prevents movement of the wheel. The contoured edges 147b of the brake shoe 147 engage against the lowermost roller(s) 149 to further strengthen the braking action. When the brake lever 140 is released, or reversed, the bar 142 moves linearly back, away from the actuating disc 144, thereby removing the downward pressure from it and the brake leg 146. The brake leg 146 springs back up, away from the coupling ring 150 and rollers 149n, thereby releasing the wheel and allowing it to rotate freely once more.

If the braking lever is provided at the rear of the stroller and it is required to provide the braking action in respect of the front wheels (instead of, or as well as the rear wheels, it will be appreciated that the lever 140 can be coupled by means of, for example, a cable to the rest of the braking mechanism at the location of the wheels. Thus, all of the wheels could be braked simultaneously, if required.

It will be apparent to a person skilled in the art, from the foregoing description, that modifications and variations can be made to the described embodiments, without departing from the scope of the invention, as claimed.

1. A foldable stroller, comprising a frame having a backrest and a seat portion, at least one leg pivotally mounted at a lower end of said frame and pivotal with respect thereto between an operable configuration in which said frame extends at an angle relative to vertical and at least one leg extends from the front of the frame, and a folded configuration in which said at least one leg is located behind said backrest, wherein a wheel is mounted at or adjacent a distal end of the or each leg, the stroller further comprising a rear mount carrying an axle on which at least one wheel is mounted, said rear mount extending, in said operable configuration, substantially vertically downward from an intermediate location along the length of said frame and being pivotally mounted to said frame such that, in a fully folded configuration, said rear mount can be pivoted to a position substantially parallel to and behind said backrest, and a rigid linking arm secured between said at least one leg and said rear mount such that when said at least one leg is pivoted, corresponding pivoting of said rear mount is effected via said linking arm, wherein a first pivot mechanism between said at least one leg and said frame is provided with a releasable lock for selectively preventing pivoting of said at least one leg relative to said lower end of said frame, said lock comprising an actuator communicably coupled to a second pivot mechanism between said mount and said frame, wherein said actuator is configured to lock said first pivot mechanism when said mount is in either said operable or said fully folded configuration, and release said first pivot mechanism during transitions between said operable and fully folded configurations.

2. A stroller according to claim 1, comprising a first releasable locking device for locking said mount in said fully folded configuration.

3. A stroller according to claim 2, comprising a single-handedly actuable release mechanism for disengaging said locking device and releasing said mount for pivotal movement relative to said frame.

4. A stroller according to any of the preceding claims, comprising a second locking device for automatically locking said second pivot mechanism when said mount is in said fully operable configuration.

5. A stroller according to claim 4, comprising a release mechanism for disengaging said second locking device and releasing said second pivot mechanism to permit pivotal movement of said mount relative to said frame.

6. A stroller according to any of the preceding claims, wherein the rear mount is secured to said frame at a substantially central location relative to the length of the stroller including said at least one leg.

7. A stroller according to any of the preceding claims, wherein said frame comprises a pair of parallel opposing, longitudinal bars, each comprising first and second bar sections, each first bar section being telescopically mounted in a respective second bar section, wherein each said first bar section configured for movement relative to a respective second bar section between a first fully extended configuration and a second fully retracted configuration.

8. A stroller according to claim 7, comprising a locking mechanism for automatically locking said first bar section relative to said second bar section when it is in either said fully extended or fully retracted configuration.

9. A stroller according to any of the preceding claims, comprising one or more handle members at or between the upper end of the frame.

10. A stroller according to claim 9, wherein a height of said one or more handle members is adjustable when said stroller is in said operable configuration.

11. A stroller according to any of the preceding claims, comprising a seat of a bucket seat configuration, having a lower portion which defines the seat portion and an upper portion extending therefrom defining the backrest.

12. A stroller according to any of the preceding claims, comprising straps in respect of the backrest, which straps are operable as a harness for securing an occupant in the stroller when in the operable configuration, and operable as shoulder straps for transporting the stroller on a user's back when in the folded configuration.

13. A stroller according to claim 11, wherein the backrest is substantially rigid such that, when the front wheel is pivoted toward the rear of the frame, in the folded configuration, the backrest can be pulled forward to provide a planar support which rests against a user's back when the stroller is being carried on their shoulders.

14. A stroller according to any of the preceding claims, wherein the frame comprises a pair of parallel bars having a lower cross bar connected therebetween, wherein the backrest and seat portion comprise a single, at least partially resilient flexible seat member, mounted between extending across substantially the whole width between the parallel bars.

15. A stroller according to any of the preceding claims, wherein the rear mount comprises a rigid, generally U-shaped support, extending from the frame and pivotally mounted thereto by means of a pair of opposing elongate pivotal linkages.

16. A stroller according to any of the preceding claims, wherein the wheel or wheels on the at least one leg and/or the axle on the rear mount comprise at least one omni wheel.

17. A stroller according to claim 16, further comprising a braking mechanism provided in respect of said at least one omni wheel.

18. A stroller according to claim 17, wherein the at least one omni wheel comprises a pair of opposing, parallel discs, each carrying a plurality of rollers around their circumferential edge, said discs being coupled together by means of a substantially concentric coupling plate defining a concentric, upstanding flange between said discs, wherein said braking mechanism comprises a substantially vertical braking leg extending generally diametrically between said discs and terminating in a brake shoe defining a recess, wherein said braking leg is biased to a first configuration in which said brake shoe is above and removed from said flange, the braking mechanism further comprising an actuating device for applying a downward force to said braking leg and causing said recess in said braking shoe to move to a second configuration in which it engages with said flange defined by said coupling ring.

19. A stroller according to claim 18, wherein said brake shoe is further provided at its circumferential edge with a pair of contoured surfaces which, upon actuation of said braking mechanism, engage with immediately adjacent rollers.

20. A stroller according to any of the preceding claims, wherein the or each wheel at the front of said stroller and the or each wheel at the rear of said stroller is provided with a braking mechanism.

21. A stroller according to claim 20, wherein a single actuation device is provided which, when actuated, causes the braking mechanism in respect of the front and rear wheels to be applied substantially simultaneously.

22. A foldable stroller substantially as herein described and/or with reference to the accompanying drawings.

23. A non-motorised conveyable vehicle comprising a frame and at least one omni wheel comprises a pair of opposing, parallel discs, each carrying a plurality of rollers around their circumferential edge, said discs being coupled together by means of a substantially concentric coupling plate defining a concentric, upstanding flange between said discs, wherein said braking mechanism comprises a substantially vertical braking leg extending generally diametrically between said discs and terminating in a brake shoe defining a recess, wherein said braking leg is biased to a first configuration in which said brake shoe is above and removed from said flange, the braking mechanism further comprising an actuating device for applying a downward force to said braking leg and causing said recess in said braking shoe to move to a second configuration in which it engages with said flange defined by said coupling ring.

24. A vehicle according to claim 23, wherein the brake shoe is further provided at its circumferential edge with a pair of contoured surfaces which, upon actuation of said braking mechanism, engage with immediately adjacent rollers.

25. A vehicle according to claim 23 or claim 24, comprising at least one wheel at its rear and at least one wheel at its front, at least one of said wheels comprising an omni-wheel, each of said wheels comprising a braking mechanism.

26. A vehicle according to claim 25, wherein a single actuation device is provided which, when actuated, causes the braking mechanism in respect of the front and rear wheels to be applied substantially simultaneously.
